(19) United States
(12) Patent Application Publication
(10) Pub. No.: US 2025/0003884 A1
(43) Pub. Date: Jan. 2, 2025

(54) SOLUTION CONCENTRATION MONITOR

(71) Applicant: KING FAISAL UNIVERSITY, Al-Ahsa (SA)

(72) Inventor: Chawki AWADA, Al-Ahsa (SA)

(21) Appl. No.: 18/216,735

(22) Filed: Jun. 30, 2023

(51) Int. Cl. G01N 21/77; G01N 21/03

(52) U.S. Cl. CPC G01N 21/77; G01N 21/0303; G01N 2021/7773; G01N 2201/0612

(57) ABSTRACT

The system includes a monochromatic diode laser, a metal film, a photo diode array, and a quartz cuvette. The system is used for monitoring concentration of a solution. The solution contains dye and is irradiated by a UV-light lamp for photo-degradation. The monochromatic diode laser has a wavelength that can penetrate the quartz and reflect on the metal film. The photo-diode array collects reflecting intensity. Different optics can be installed to disperse, collimate and focus the light into the photodiode connected to a PC, where software can record the reflectivity variation versus wavelength or time. The film can be positioned inside or outside the solution or in a bottom of the cuvette. The quartz cuvette used can be a container, glass beaker, etc.

### BACKGROUND

### 1. Field

The present disclosure relates to determining the concentration of a solution, and particularly to determining the concentration of a solution using a laser.

### 2. Description of the Related Art

Knowing the concentration of a solution is important in many areas. Water purity can be important to ensure a community is using water meeting certain purity standards. Concentration can be important for ensuring the quality of foods. Pharmaceuticals will require the utmost care in determining concentration as including the wrong dosage could literally be a matter of life or death. Other industries such as chemical engineering and materials sciences require an accurate way of determining the concentration of a solution.

Titrations are sometimes used to determine concentrations of solutions. A titrant is added to the solution until there is no reaction. The volume of the titrant added is then recorded. The concentration of the solution can then be determined from the volume of the titrant added. This process is time consuming.

Accordingly, a new system and method for determining the concentration of a solution solving the aforementioned problems is desired.

### SUMMARY

The concentration of a solution can be measured in a system using a reflectivity effect during a photo-degradation process. A monochromatic diode laser, a metal film, a photo diode array, and a quartz cuvette can be included in the system. The solution can contain dye and can be irradiated by a UV-light lamp for photo-degradation. A laser beam emitted from the monochromatic diode laser can have a wavelength that can penetrate the quartz and reflect on the metal film. The photo-diode array can collect reflecting intensity. Different optics can be installed to disperse, collimate, and focus the light into the photodiode connected to a PC, where software can record the reflectivity variation versus wavelength or time. The film can be positioned inside or outside the solution or in a bottom of the cuvette. The quartz cuvette used can be a container, glass beaker, etc.

A solution concentration monitor, in one embodiment, can include: a cuvette; a UV light lamp positioned to irradiate a solution in the cuvette; a film located proximal to the cuvette; a laser source positioned to direct a laser through the cuvette and to reflect off the film; and a photodiode positioned to receive the laser reflected off the film.

In another embodiment, the solution concentration monitor can further include a lens positioned to focus the laser reflected off the film to the photodiode.

A mirror can also be positioned to direct the laser from the laser source through the cuvette and to reflect off the film.

The mirror can further reflect the laser reflected off the film.

A lens can be positioned to focus the laser reflected off the mirror to the photodiode.

A data acquisition system can be included to be in communication with the photodiode to collect data from the photodiode.

In certain embodiments, the solution concentration monitor can further include a computer in communication with the photodiode to collect and analyze data from the photodiode.

The film can be gold, silver, chrome or any other type of film having a smooth surface.

The laser source can be a monochromatic diode laser.

In another embodiment, the present subject matter relates to a method of monitoring the concentration of a solution in a cuvette, including: irradiating the solution in the cuvette with a UV light lamp; directing a laser from a laser source through the cuvette to reflect off a film located proximal to the cuvette; and receiving the laser reflected off the film with a photodiode.

The laser reflected off the film can be focused onto the photodiode through a lens.

The laser, directed from the laser source, can directed through a mirror before going through the cuvette.

The mirror can further reflect the laser reflected off the film.

The laser reflected off the mirror can be focused on the photodiode through a lens.

The method can further include communicating data collected from the photodiode to a data acquisition system.

The method can also include communicating data collected from the photodiode to a computer that analyzes the data.

The film can be gold, silver, chrome or any other type of film having a smooth surface.

The laser source can be a monochromatic diode laser.

The solution can be an aqueous solution containing a dye.

These and other features of the present subject matter will become readily apparent upon further review of the following specification.

### BRIEF DESCRIPTION OF THE DRAWINGS

FIG. 1 is an illustration of a solution concentration monitor.

FIG. 2 is a flow diagram of a method of monitoring the concentration of a solution.

Similar reference characters denote corresponding features consistently throughout the attached drawings.

### DETAILED DESCRIPTION OF THE PREFERRED EMBODIMENTS

The following detailed description is merely exemplary in nature and is not intended to limit the described embodiments or the application and uses of the described embodiments. Any implementation described herein with the words “exemplary” or “illustrative” is not necessarily construed as preferred or advantageous over other implementations. All of the implementations described below are exemplary implementations provided to enable persons skilled in the art to make or use the embodiments of the disclosure and are not intended to limit the scope of the disclosure, which is defined by the claims.

For the purposes of the description herein, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed therein are not to be considered as limiting, unless the claims expressly state otherwise.

The concentration of a solution can be monitored based on the reflection of light into a metal surface such gold placed on the side of a quartz cuvette. In an embodiment, the solution can be an aqueous solution containing dye that is irradiated by a UV-light lamp for photo degradation. The source can be a monochromatic diode laser in which its wavelength can penetrate the quartz and reflect on the metal film. The reflecting intensity can be collected by a photodiode array. Different optics can be installed in order to disperse, collimate and focus the light into the photodiode connected to a PC where software can record the reflectivity variation versus wavelength or time. The monitor can be developed without a grating by using a single photon counter photodiode. Also, the position of the film can be inside the solution, outside the solution, or in the bottom of the cuvette.

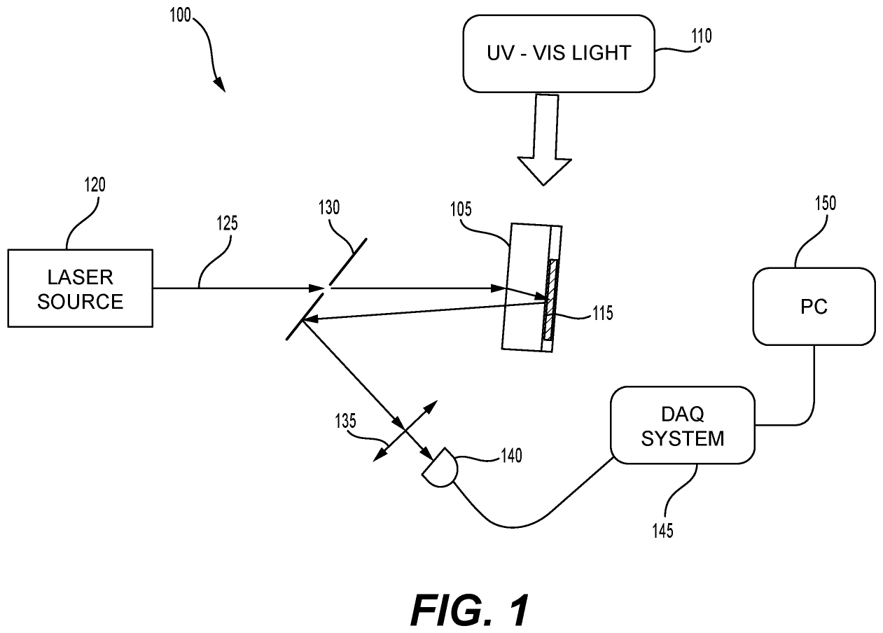

FIG. 1 is an illustration of a solution concentration monitor 100. A cuvette 105 contains a solution. The cuvette 105 can be any type of container such as a glass beaker, quartz container, or the like. Any aqueous solution containing any dye can be used. In general, the concentration of dye can be about 10⁻⁵ M, permitting the laser to easily penetrate the solution.

A UV light lamp 110 is positioned to irradiate the solution in the cuvette 105. The solution can be an aqueous solution containing a dye which is irradiated by the UV light lamp 110 for photo degradation.

A film 115 is located proximal to the cuvette 105. The film 115 can be gold, silver, chrome, or any other type of metal having a smooth surface. Placement of the film 115 can be inside the solution, outside of the solution, or in the bottom of the cuvette 105.

A laser source 120 is positioned to direct a laser 125 through a mirror 130 and the cuvette 105, to reflect off the film 115. The laser source 120 can be a monochromatic laser diode having a wavelength that can penetrate the cuvette 105 and reflect off the film 115. Some non-limiting examples of wavelengths that can be used are 532 nm, 632.8 nm, and 1064 nm, MIR. The laser wavelength is not limited and is dependent on the dye resonant wavelength.

The mirror 130 further reflects the laser 125 reflected off the film 115. A lens 135 is positioned to focus the laser 125 reflected off the mirror 130 to the photodiode 140. The photodiode 140 collects reflecting intensity. Different optics can be installed in order to disperse, collimate and focus the light into the photodiode 140.

A data acquisition system 145 is in communication with the photodiode 140 to collect data from the photodiode 140. A computer 150 is in communication with the data acquisition system 145 to analyze the data collected. The data acquisition system 145 may be a part of the computer 150. The computer 150 records the reflectivity variation versus wavelength or time. The concentration of the fluid can then be determined and output to a user.

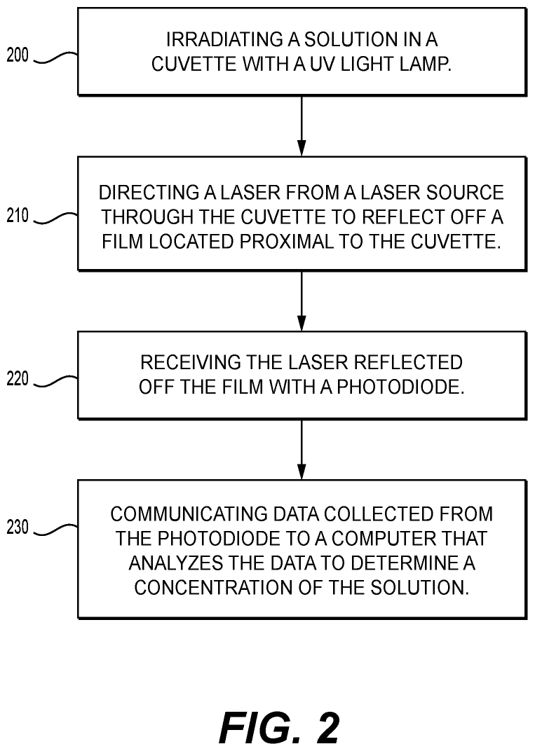

FIG. 2 is a flow diagram of a method of monitoring the concentration of a solution in a cuvette. The solution in the cuvette is irradiated with a UV light lamp in box 200. A laser is directed from a laser source through the cuvette to reflect off a film located proximal to the cuvette in box 210. The laser reflected off the film is received by a photodiode in box 220. The data collected from the photodiode is communicated to a computer that analyzes the data to determine a concentration of the solution in box 230.

The laser reflected off the film can be focused onto the photodiode through a lens.

The laser, directed from the laser source, can be directed through a mirror before going through the cuvette.

The mirror can further reflect the laser reflected off the film.

The laser reflected off the mirror can be focused on the photodiode through a lens.

The method can further include communicating data collected from the photodiode to a data acquisition system.

The film can be gold, silver, chrome or any other type of film having a smooth surface.

The laser can be a monochromatic diode laser.

The solution can be an aqueous solution containing a dye.

It is to be understood that the monitoring of the concentration of a solution is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A solution concentration monitor, comprising:
a cuvette containing a dye contained within a solution;
a UV light lamp positioned to irradiate the dye contained within the solution in the cuvette;
a film located proximal to the cuvette;
a laser source positioned to direct a laser through the cuvette and to reflect off the film wherein a wavelength of the laser is dependent upon a dye resonant wavelength of the dye contained within the solution and where said wavelength of the laser is chosen such that the laser can easily penetrate the solution; and
a photodiode positioned to receive the laser reflected off the film, wherein the film reflects the directed laser towards the photodiode, and
wherein the UV light lamp is positioned on a top surface of the cuvette and the laser source is placed almost perpendicular to a placement of the UV light lamp.

2. The solution concentration monitor as recited in claim 1, further comprising a lens positioned to focus the laser reflected off the film to the photodiode.

3. The solution concentration monitor as recited in claim 1, further comprising a mirror positioned to direct the laser from the laser source through the cuvette and to reflect off the film.

4. The solution concentration monitor as recited in claim 3, wherein the mirror further reflects the laser reflected off the film to the photodiode.

5. The solution concentration monitor as recited in claim 4, further comprising a lens positioned to focus the laser reflected off the mirror to the photodiode.

6. The solution concentration monitor as recited in claim 1, further comprising a data acquisition system in communication with the photodiode to collect data from the photodiode.

7. The solution concentration monitor as recited in claim 1, further comprising a computer in communication with the photodiode to collect and analyze data from the photodiode.

8. The solution concentration monitor as recited in claim 1, wherein the film is gold, silver, or chrome.

9. The solution concentration monitor as recited in claim 1, wherein the laser source is a monochromatic diode laser.

10.-19. (canceled)
